(19) United States
(12) Patent Application Publication
(10) Pub. No.: US 2017/0053449 A1
(43) Pub. Date: Feb. 23, 2017

(54) APPARATUS FOR PROVIDING VIRTUAL CONTENTS TO AUGMENT USABILITY OF REAL OBJECT AND METHOD USING THE SAME

(71) Applicant: ELECTRONICS AND TELECOMMUNICATIONS RESEARCH INSTITUTE, Daejeon (KR)

(72) Inventors: Joo-Haeng LEE, Daejeon (KR); Jae-Hong KIM, Daejeon (KR); Woo-Han YUN, Daejeon (KR); A-Hyun LEE, Seoul (KR); Jae-Yeon LEE, Daejeon (KR)

(21) Appl. No.: 15/239,037

(22) Filed: Aug. 17, 2016

(30) Foreign Application Priority Data
Aug. 19, 2015 (KR) 10-2015-0116923
Jun. 2, 2016 (KR) 10-2016-0068861

(51) Int. Cl. G06T 19/00; G06F 3/01; G06K 9/62

(52) U.S. Cl. CPC G06T 19/006; G06K 9/6267; G06F 3/011; G06T 2200/04

(57) ABSTRACT

A virtual content provision apparatus and method for augmenting usability of a real object. The virtual content provision apparatus includes a real object information acquisition unit for acquiring real object information corresponding to a real object through an input module, a virtual content search unit for searching for any one piece of virtual content based on the real object information, a virtual interface projection unit for projecting a virtual interface corresponding to the virtual content onto the real object through an output module, a user input detection unit for detecting user input on the virtual interface based on the input module, and a virtual content provision unit for, when the user input is detected, extracting virtual information related to the user input based on the virtual content, and projecting and providing the virtual information to correspond to the real object information through the output module.

### CROSS REFERENCE TO RELATED APPLICATIONS

This application claims the benefit of Korean Patent Application No. 10-2015-0116923, filed Aug. 19, 2015 and 10-2016-0068861, filed Jun. 2, 2016, which are hereby incorporated by reference in their entirety into this application.

### BACKGROUND OF THE INVENTION

1. Technical Field

The present invention relates generally to technology for providing virtual information or content and, more particularly, to technology for augmenting the usability of an object in the real world, which may recognize work situations and may directly display information, content, and interfaces suitable for the work situations on a surface in the real world when extending the physical function of an object in the real word and enhancing the usability of the object.

2. Description of the Related Art

Recently, interest in virtual-, augmented-, and mixed-reality technology has increased. In this context, major global Information Technology (IT) companies have competed in the release of wearable glasses. To date, Google, Facebook, Amazon, etc. have accumulated information, existing in the real word, in virtual storage using various types of methods. This means that the so-called big data age has arrived. Further, deep learning technology for processing such big data has been rapidly developed. Here, current virtual-, augmented-, and mixed-reality technology has been developed into a combination with computer graphics and user interaction technology that has been developed in another context.

There are limitations on the ability to express big data owned by global IT enterprises to the real world based on service merely by utilizing existing computers and existing mobile devices. For example, advertising markets, available when searching, have already reached saturation status. However, when augmented-, virtual-, and mixed-reality devices are utilized, a new channel that enables massive information and services accumulated in the virtual world to be exposed to the real world may be realized. Google glasses, Facebook Oculus Rift, Microsoft HoloLens, and HP Sprout may be relevant to this business context.

However, those wearable devices are disadvantageous in that the display and real-world objects are separate, and thus a user may feel very awkward at the surface on which images are registered (matched). Further, when the user moves or shakes his or her hand, it is very unnatural to realize information registration with a 3D real object. Furthermore, there are many cases where such a device itself cannot be worn. For example, it is difficult to prompt a small child or an old person to use separate glasses or a separate smart pad.

Therefore, there is urgently required new technology that enables natural interaction to be made as if a user were naturally interacting with a physical object as usual without requiring a separate wearing device and without holding a smart pad in his or her hand.

In connection with this, Korean Patent Application Publication No. 10-2005-0029172 discloses a technology related to “Projector-Camera System and Focusing Method for Augmented Reality Environment.”

### SUMMARY OF THE INVENTION

Accordingly, the present invention has been made keeping in mind the above problems occurring in the prior art, and an object of the present invention is to provide an additional function suitable for a physical object in the real world, beyond the intrinsic functions of the physical object, based on augmented-reality technology.

Another object of the present invention is to provide virtual information based on virtual content projected through a projector without requiring a user to wear separate wearable glasses, thus decreasing dependency on a portable device carried by the user and allowing the user to experience the augmentation of the usability of an object regardless of the user's ability to utilize the device and regardless of the age of the user.

A further object of the present invention is to search for virtual content corresponding to the situation in the real world by recognizing the situation in the real world through a camera, and to provide more effective virtual content by designing and providing the virtual content in conformity with the environment in the real world.

In accordance with an aspect of the present invention to accomplish the above objects, there is provided a virtual content provision apparatus for augmenting usability of a real object, including a real object information acquisition unit for acquiring real object information corresponding to a real object through an input module; a virtual content search unit for searching for any one piece of virtual content based on the real object information; a virtual interface projection unit for projecting a virtual interface corresponding to the one piece of virtual content onto the real object through an output module; a user input detection unit for detecting user input on the virtual interface based on the input module; and a virtual content provision unit for, when the user input is detected, extracting virtual information related to the user input based on the one piece of virtual content, and projecting and providing the virtual information to correspond to the real object information through the output module.

The virtual content provision unit may deliver the user input to content logic corresponding to the one piece of virtual content, and acquire next state information depending on the user input as the virtual information based on the content logic.

The real object information may include at least one of object information corresponding to at least one of a kind and a shape of the real object and environmental information corresponding to the real object.

The virtual content provision unit may be configured to generate an image corresponding to the virtual information generated using at least one of homography, a projected texture, sound, and video, based on the virtual information, and to project the image into an area corresponding to at least one of the real object and the environmental information.

The input module may be at least one of a sensor, a camera, and a depth camera that correspond to at least one of location, orientation, temperature, body temperature, blood pressure, length, illuminance, and radio frequency identification (RFID).

The output module may be a projector capable of projecting the virtual information as an image.

The virtual content provision apparatus may further include a virtual content database for storing and managing the one piece of virtual content so that the real object matches the one piece of virtual content.

The virtual content search unit may acquire the one piece of virtual content through an external service based on a network if any one piece of virtual content is not found in the virtual content database.

The virtual content search unit may be configured to, if any one piece of virtual content is acquired through the external service, store the one piece of virtual content in the virtual content database so that the one piece of virtual content is associated with the real object information.

The output module may be installed such that both the real object and the environmental information are included in a projection range corresponding to the output module.

In accordance with another aspect of the present invention to accomplish the above objects, there is provided a virtual content provision method for augmenting usability of a real object, including acquiring real object information corresponding to a real object through an input module; searching for any one piece of virtual content based on the real object information, and projecting a virtual interface corresponding to the one piece of virtual content onto the real object through an output module; detecting user input on the virtual interface based on the input module; and when the user input is detected, extracting virtual information related to the user input based on the one piece of virtual content, and projecting and providing the virtual information to correspond to the real object information through the output module.

Projecting and providing the virtual information may include delivering the user input to content logic corresponding to the one piece of virtual content; and acquiring next state information depending on the user input as the virtual information based on the content logic.

The real object information may include at least one of object information corresponding to at least one of a kind and a shape of the real object and environmental information corresponding to the real object.

Projecting and providing the virtual information may be configured to generate an image corresponding to the virtual information generated using at least one of homography, a projected texture, sound, and video, based on the virtual information, and to project the image into an area corresponding to at least one of the real object and the environmental information.

The input module may be at least one of a sensor, a camera, and a depth camera that correspond to at least one of location, orientation, temperature, body temperature, blood pressure, length, illuminance, and radio frequency identification (RFID).

The output module may be a projector capable of projecting the virtual information as an image.

The virtual content provision method may further include storing and managing the one piece of virtual content in a virtual content database so that the real object matches the one piece of virtual content.

Projecting the virtual interface may include acquiring the one piece of virtual content through an external service based on a network if any one piece of virtual content is not found in the virtual content database.

Projecting the virtual interface may further include if any one piece of virtual content is acquired through the external service, storing the one piece of virtual content in the virtual content database so that the one piece of virtual content is associated with the real object information.

The output module may be installed such that both the real object and the environmental information are included in a projection range corresponding to the output module.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a concept for augmenting functionality in physical law-based interaction according to an embodiment of the present invention;

FIG. 2 is a diagram showing a concept for adding an interactive channel to an object in the real world in association with a virtual world according to an embodiment of the present invention;

FIG. 3 is a diagram showing a virtual content provision system for augmenting the usability of a real object according to an embodiment of the present invention;

FIG. 4 is a block diagram showing a virtual content provision apparatus for augmenting the usability of a real object according to an embodiment of the present invention;

FIG. 5 is a diagram showing a processing structure for the virtual content provision apparatus according to an embodiment of the present invention;

FIGS. 6 and 7 are diagrams showing a mirror utilization structure for projection according to an embodiment of the present invention;

FIG. 8 is an operation flowchart showing a virtual content provision method for augmenting the usability of a real object according to an embodiment of the present invention;

FIG. 9 is a diagram showing an example of a virtual game screen using the virtual content provision apparatus according to the present invention;

FIGS. 10 to 18 are diagrams showing an embodiment of virtual game content using the virtual content provision apparatus according to the present invention;

FIGS. 19 to 22 are diagrams showing an embodiment of tangram content using the virtual content provision apparatus according to the present invention; and

FIGS. 23 to 27 are diagrams showing an embodiment of educational content using the virtual content provision apparatus according to the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc of components in the drawings may be exaggerated to make the description clearer.

Hereinafter, preferred embodiments of the present invention will be described in detail with reference to the attached drawings.

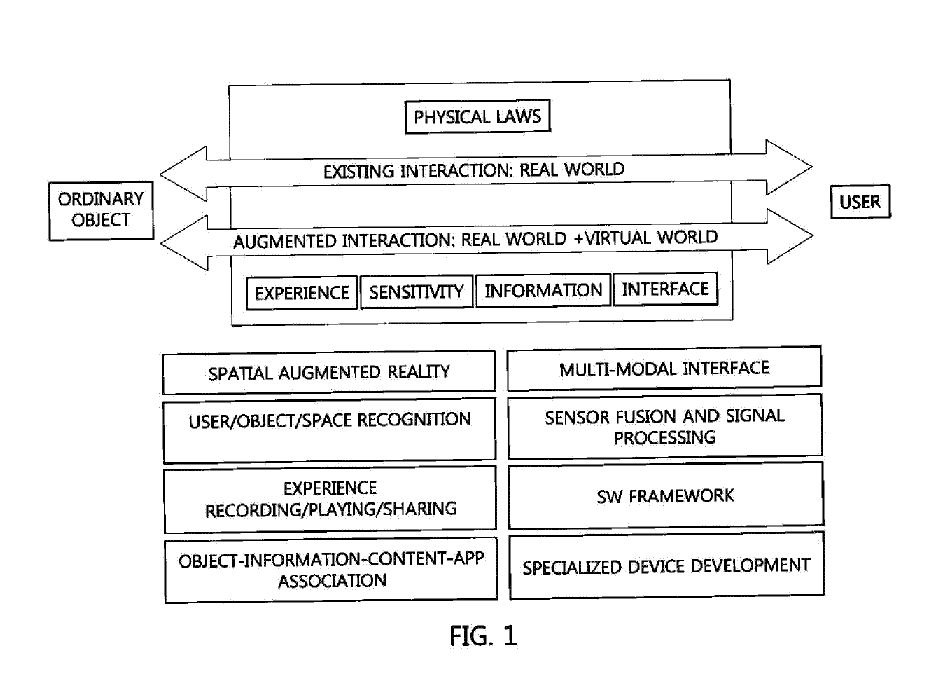

FIG. 1 is a diagram showing a concept for augmenting functionality in physical law-based interaction according to an embodiment of the present invention.

Referring to FIG. 1, the augmentation of functionality in physical law-based interaction according to the embodiment of the present invention may correspond to the provision of an additional function that may be provided by an ordinary object in a virtual world, beyond functions that may be provided by the ordinary object in the real world.

That is, the number of functions that may be provided while the ordinary object interacts with the user may be increased by providing a virtual world or virtual content based on an ordinary object by means of technology that uses virtual, augmented, and mixed reality.

In existing technology using virtual, augmented, and mixed reality, there is more interest in elemental technology related to how to display information, acquired via interaction between an ordinary object and a user, to the user and how to interact with an interface.

However, the present invention may add new functions by adding information, content, and an interface pertaining to the virtual world to the existing ordinary object that follows physical laws, and may enhance the user's experience in utilizing the ordinary object, thus providing an effect similar to improving the physical functionality of the ordinary object.

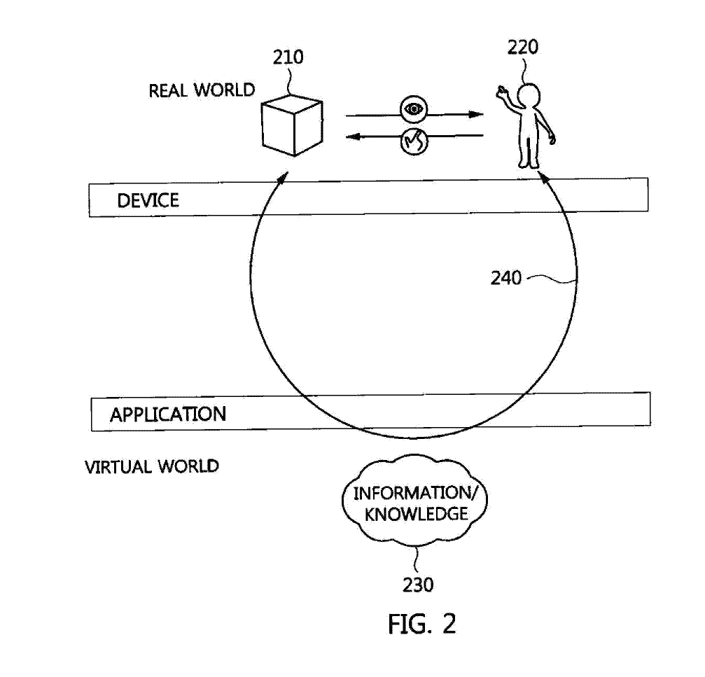

FIG. 2 is a diagram showing a concept for adding an interactive channel to an object in the real world in association with a virtual world according to an embodiment of the present invention.

Referring to FIG. 2, there may be understood a structure for technology capable of augmenting functions provided while a real object 210 in the real world interacts with a user 220 by associating the real object 210 in the real world with the virtual world.

In FIG. 2, an object indicated by a box may represent an ordinary physical object, that is, the real object 210.

Here, FIG, 2 illustrates an example in which the real object 210 and the user 220 mainly interact with each other via visual sensation and tactile sensation. That is, when the virtual world and augmented interaction are not taken into consideration, the user 220 may interact with the real object 210 via visual sensation and tactile sensation based on physical laws. Therefore, the user 220 may utilize the intrinsic functions of the real object 210 based on physical laws.

The method for providing virtual content presented by the present invention is intended to provide a new interactive channel 240, as shown in FIG. 2, which enables new functions to be added to the existing functions of the real object 210 and to be utilized.

Here, the functions that are newly added to the real object 210 may chiefly utilize information, knowledge, and content 230 pertaining to the virtual world. The new functions are imparted with a shape or an interface by light projected through a projector, and the user personally touches the projected interface, thus enabling interaction to be made.

Here, the hand gesture of the user may be recognized mainly by exploiting a camera, a depth camera, and a sensor.

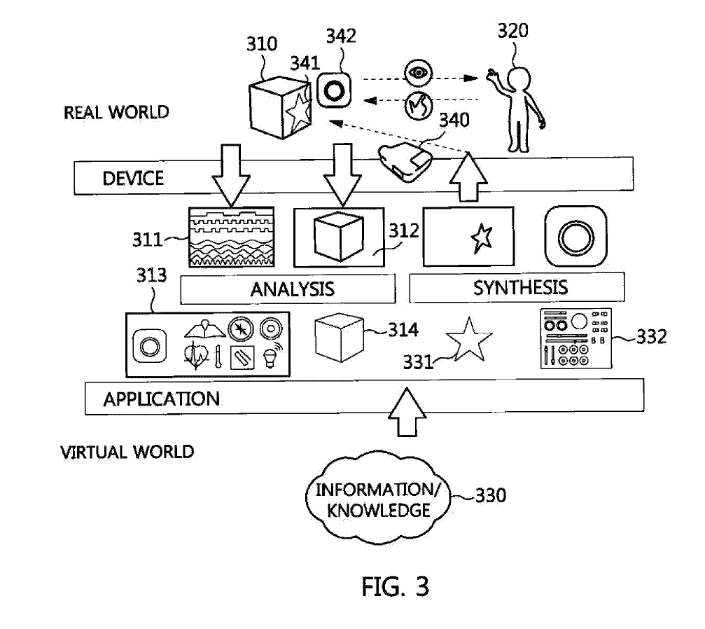

FIG. 3 is a diagram showing a virtual content provision system for augmenting the usability of a real object according to an embodiment of the present invention.

Referring to FIG. 3, in the virtual content provision system for augmenting the usability of a real object according to the embodiment of the present invention, information, knowledge, and content 330 pertaining to the virtual world, which are to be added to a real object 310, may be determined in conformity with the situation in which the real object 310 is used.

First, in order to determine the situation of the real object 310, a procedure for recognizing the real object 310 itself may be required. For this, image data 312 may be acquired by capturing an image of the real object 310 through a camera, and the kind or shape 314 of the object may be recognized by analyzing the image data 312. In this case, various sensors may also be used to collect additional environmental information about the real object 310.

For example, various signals 311 in the real word may be collected through the sensors and may be analyzed, and thus environmental information 313, such as the location, orientation, temperature, body temperature, blood pressure, length, and illuminance, may be acquired.

In this case, an important function of an application may be the determination of the information, knowledge, and content 330 pertaining to the virtual world by utilizing information corresponding to the kind or shape 314 of the real object 310 and the environmental information 313 as contextual information.

Here, the application may be either the virtual content provision apparatus according to the embodiment of the present invention or an application running on the virtual content provision apparatus.

Further, the application may generate logic for adaptively representing the information, knowledge, and content 330 in accordance with the situation in the real world, and providing the possibility of control.

Here, the logic may be represented by various methods, for example, a method of changing the font size or color of information to be added in consideration of the user's preferences, or a method of configuring menus corresponding to tasks.

In this regard, the information, knowledge, and content 330 selected by the application may be projected into the real world in the form of content 331 or an interface 332, together with the logic. At this time, a projected image may be processed in a suitable form so that it may be registered with a surface in the real world.

For example, in the case of a plane, homography may be utilized, and in the case of a solid body, the shape of which is known, a texture projection method may be utilized.

Here, a star 341 itself indicated on a box in FIG. 3 may be selected by the application, and a method for registering the star may determine the image to be projected in consideration of the shape 314 of the real object 310 and the environmental information 313.

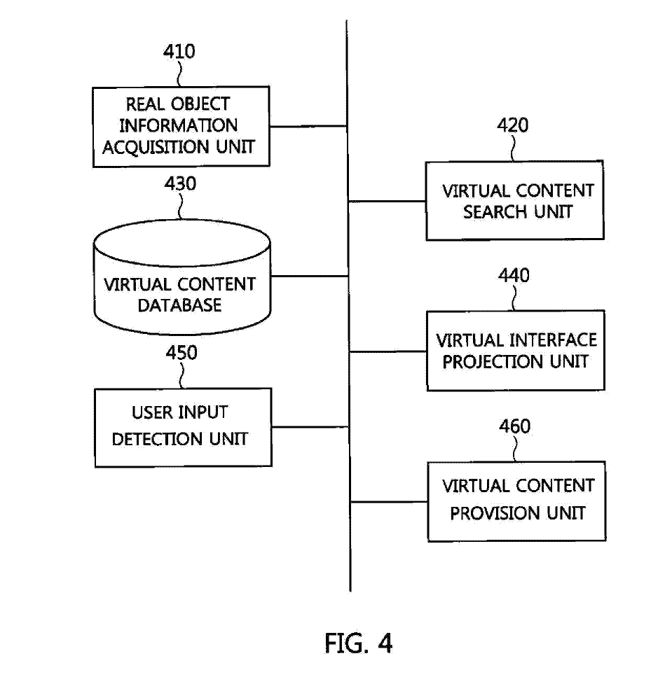

FIG. 4 is a block diagram showing a virtual content provision apparatus for augmenting the usability of a real object according to an embodiment of the present invention.

Referring to FIG. 4, the virtual content provision apparatus for augmenting the usability of a real object according to the embodiment of the present invention may include a real object information acquisition unit 410, a virtual content search unit 420, a virtual content database (DB) 430, a virtual interface projection unit 440, a user input detection unit 450, and a virtual content provision unit 460.

The real object information acquisition unit 410 acquires real object information corresponding to a real object through an input module.

Here, the real object information may include at least one of object information corresponding to at least one of the kind and shape of the real object and environmental information corresponding to the real object.

For example, assuming that the real object is a game board for a board game, information about the shape of the game board, game pieces to be used for a game, etc. may be recognized as object information, and information about the position of the game board, the positions of the game pieces, etc may be acquired as environmental information.

As another example, assuming that a textbook placed on the desk of a user is a real object, information about the shape, kind, etc of the textbook may be acquired as object information, and information about a notebook placed on the desk, the ambient illuminance, etc of the desk may be acquired as environmental information.

Here, the input module may be at least one of a sensor, a camera, and a depth camera that correspond to at least one of location, orientation, temperature, body temperature, blood pressure, length, illuminance, and radio frequency identification (RFID).

In this case, since there are many cases where the recognition of a hand gesture of the user or a three-dimensional (3D) object is required, a depth camera may be essentially used.

The virtual content search unit 420 searches for any one piece of virtual content based on the real object information.

For example, when real object information about a piano book is acquired through the input module, virtual content related to a piano, piano scores, or piano performance video may be found as a result of the search.

Here, when any one piece of virtual content is not found in the virtual content DB 430, any one piece of virtual content may be acquired through an external service based on a network For example, virtual content may be acquired based on Wolfram|Alpha or Google Application Program Interface (API).

When any one piece of virtual content is acquired through the external service, the acquired virtual content may be stored in the virtual content DB 430 so that the virtual content is associated with the real object information. The virtual content acquired through the external service is stored and managed in this way, and thus it is possible to search the virtual content DB 430 for the corresponding virtual content and provide found virtual content without again searching for virtual content through the external service even if the user subsequently requests virtual content based on the same real object.

The virtual content DB 430 stores and manages the one piece of virtual content so that the real object matches the one piece of virtual content. For example, the virtual content may be stored such that an identifier enabling the virtual content to be identified matches object information corresponding to the real object.

The virtual interface projection unit 440 projects a virtual interface corresponding to the one piece of virtual content onto the real object through the output module.

Here, the output module may be a projector capable of projecting virtual information or a virtual interface based on the virtual content as an image.

The output module may be installed such that both the real object and environmental information are included in the projection range corresponding to the output module. For example, when the real object is a textbook placed on a desk, the output module may be installed such that the projection range corresponds to the surface of the desk in order to use a note or pen placed on the desk, as well as the textbook, through the virtual content.

Further, the output module may be installed so as to be spaced a predetermined distance apart from a projection surface on which an image is projected or may be installed using a mirror so that the projection range may be secured. For example, the angles of the projector corresponding to the output module and the mirror may be calculated, and thus the projector and the mirror may be installed such that the projection range is precisely maintained in a rectangular shape.

Here, the reason for maintaining the projection range in a rectangular shape is that perspective distortion on a projected screen may be prevented, and thus such maintenance may be very important in projection-based display.

The user input detection unit 450 detects user input on the virtual interface based on the input module.

Here, the user input may be detected based on a separate marker and a separate input tool recognized by the virtual content provision apparatus, and may be mostly detected based on the hand gesture of the user. Therefore, an image of the 3D hand gesture of the user may be captured using a depth camera, and the captured image may be acquired as the user input.

The virtual content provision unit 460 extracts virtual information related to user input based on the one piece of virtual content when the user input is detected, and projects and provides the virtual information to correspond to the real object information through the output module.

Here, the virtual information may correspond to the format of text, an image, video, sound or an interface according to the virtual content. For example, assuming that the virtual content is content related to English education, the virtual information may be either text including the interpretation of English or sound read to provide pronunciation. As another example, when the user performs a task using a tool or parts on a worktable, the virtual information may indicate the assembly method, assembly length or assembled positions for the parts on real parts.

In this case, the user input may be delivered to content logic corresponding to the one piece of virtual content, and next state information depending on the user input may be acquired as virtual information based on the content logic. For example, assuming that virtual content is a game having multiple stages, and user input for movement to a next stage is detected, the content logic may provide next stage information, which is the next state information depending on the user input, as the virtual information.

In this regard, an image corresponding to the virtual information generated using at least one of homography, a projected texture, sound, and video based on the virtual information may be generated, and the image may be projected into an area corresponding to at least one of the real object and the environmental information. When the virtual information corresponds to a plane, an image may be generated using homography, and when the virtual information is a solid object, the shape of which is known, an image may be generated using a projected texture.

By utilizing such a virtual content provision apparatus, an additional function suitable for a physical object in the real word may be provided, beyond the intrinsic functions of the physical object, based on augmented-reality technology.

Further, the present invention may provide virtual information based on virtual content projected through a projector without requiring a user to wear separate wearable glasses.

Furthermore, the present invention may search for virtual content corresponding to the situation in the real world by recognizing the situation in the real world through a camera, and may provide more effective virtual content by designing and providing the virtual content in conformity with the environment in the real world.

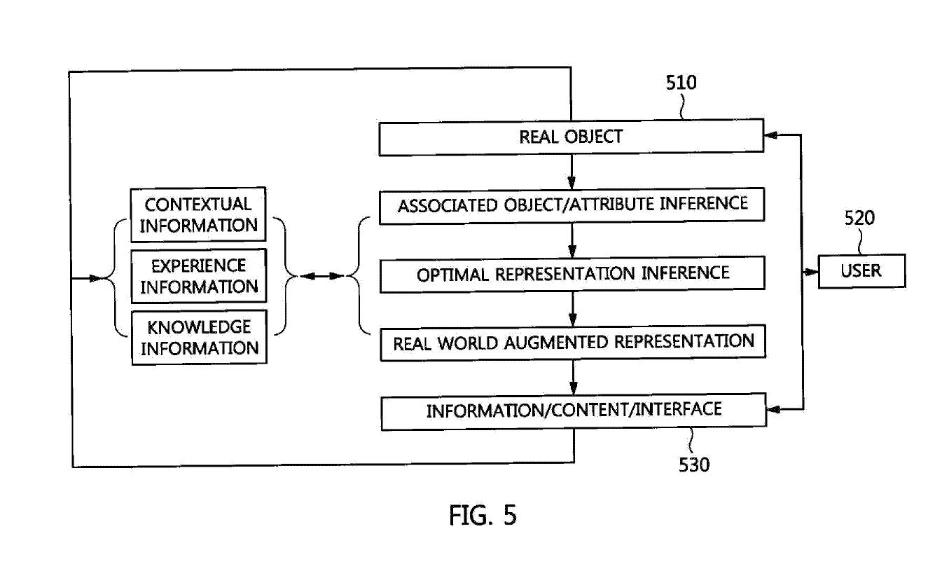

FIG. 5 is a diagram showing a processing structure for the virtual content provision apparatus according to an embodiment of the present invention.

Referring to FIG. 5, since the virtual content provision apparatus according to the embodiment of the present invention uses information technology, interaction based on augmented usability may be recorded in the form of an experience, unlike physical interaction.

Here, the recorded experience may be reproduced in a suitable form as desired.

For example, even in the situation in which a user 520 opens a piano book corresponding to a real object 510 on a desk, the virtual content provision system may infer associated objects out of the situation by understanding the situation. That is, a piano itself, corresponding to the piano book, may be inferred.

Further, in consideration of the situation in which the piano book is placed, it is determined that a piano having a suitable size may be represented in the space on the desk using augmented reality, and thereafter the piano may be represented by virtual information 530 based on augmented representation using a method such as homography.

In this way, the virtual piano displayed to the user 520 may make sounds in response to the user's touch. Further, when the performance of the user 520 is related to a score in the current piano book, recordings of past performances may be played as video or, alternatively, related images may be searched for on YouTube or the like and may then be projected. That is, this structure may be regarded as an example in which a new function is added to the piano book, which is the real object 510, and then the usability of the real object 510 is augmented.

Here, the virtual content provision system according to the embodiment of the present invention may provide the driving of a camera and a sensor for input, the driving of the projector for output, the running of the application, and access to virtual world information and knowledge.

In this regard, the information and knowledge pertaining to the virtual world may be contained in the virtual content provision apparatus, or may be accessed and obtained through an external service. For example, information and knowledge pertaining to the virtual world may be acquired based on Wolfram|Alpha, Google API or the like.

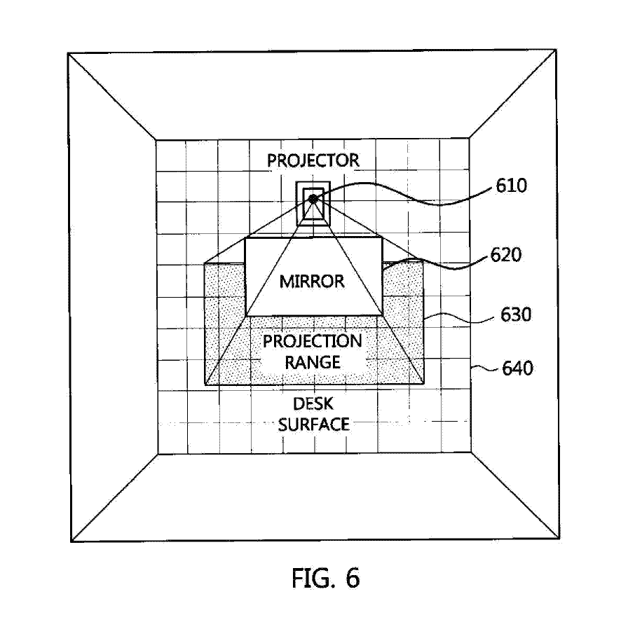

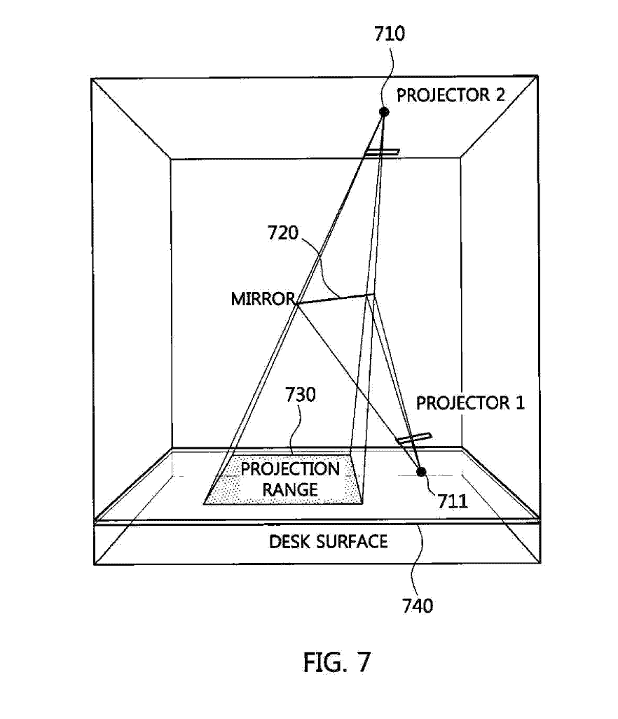

FIGS. 6 and 7 are diagrams showing a mirror utilization structure for projection according to an embodiment of the present invention.

Referring to FIGS. 6 and 7, an example in which a mirror 620 or 720 is arranged when a projector 610 or 710 is installed in a work space for the present invention may be seen.

Here, when the projector 610 or 710 is not a wide-angle projector, a predetermined distance must be secured between a projection surface and the projector 610 or 710 in order to secure a projection range 630 or 730 having a predetermined area.

However, when the weight of the projector 610 or 710 or the presence or absence of a ceiling on which the projector 610 or 710 may be mounted is taken into consideration, it may be difficult to secure the distance required to secure the projection range 630 or 730.

Here, the projection distance required by the projector 610 or 710 may be greatly reduced using the properties of light and mirror reflection.

For example, referring to FIG. 7, in order to secure the projection range 730 without using the mirror 720, the projection distance from the location of the projector 2 710 to a desk surface 740 is required. However, when the mirror 720 is arranged at a suitable location, as shown in FIG. 7, the projection range 730 having the same area may be secured even at the location of a projector 1 711.

Here, in the case of a calibrated projector, the angles of the mirror and the projector may be calculated, and the projection range may be precisely maintained in a rectangular shape. Here, since maintaining the projection range in the rectangular shape may prevent the occurrence of perspective distortion on a projected screen, it may be an item that is to be considered to be very important in projection-based display.

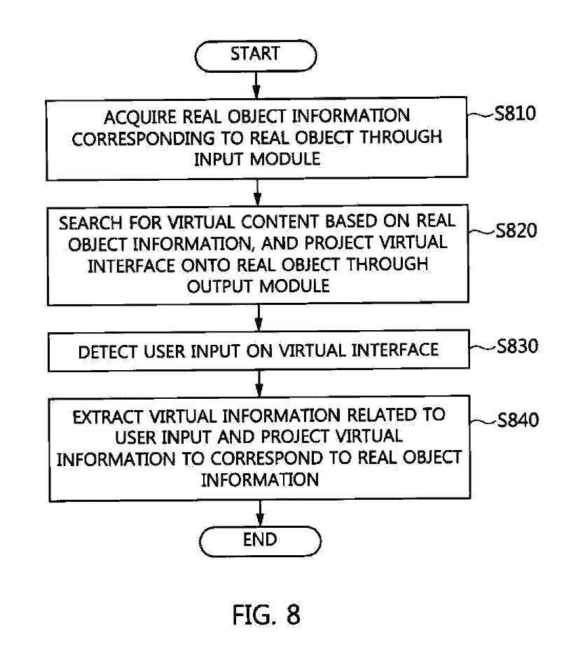

FIG. 8 is an operation flowchart showing a virtual content provision method for augmenting the usability of a real object according to an embodiment of the present invention.

Referring to FIG. 8, the virtual content provision method for augmenting the usability of a real object according to the embodiment of the present invention acquires real object information corresponding to a real object through an input module at step S810.

Here, the real object information may include at least one of object information corresponding to at least one of the kind and shape of the real object and environmental information corresponding to the real object.

For example, assuming that the real object is a game board for a board game, information about the shape of the game board, game pieces to be used for a game, etc may be recognized as object information, and information about the position of the game board, the positions of the game pieces, etc may be acquired as environmental information.

As another example, assuming that a textbook placed on the desk of a user is a real object, information about the shape, kind, etc of the textbook may be acquired as object information, and information about a notebook placed on the desk, the ambient illuminance, etc of the desk may be acquired as environmental information.

Here, the input module may be at least one of a sensor, a camera, and a depth camera that correspond to at least one of location, orientation, temperature, body temperature, blood pressure, length, illuminance, and RFID.

In this case, since there are many cases where the recognition of a hand gesture of the user or a 3D object is required, a depth camera may be essentially used.

Further, the virtual content provision method for augmenting the usability of a real object according to the embodiment of the present invention may search for any one piece of virtual content based on the real object information, and may project a virtual interface corresponding to the one piece of virtual content onto the real object through an output module at step S820.

For example, when real object information about a piano book is acquired through the input module, virtual content related to a piano, piano scores, or piano performance video may be found as a result of the search.

Here, when any one piece of virtual content is not found in the virtual content DB, any one piece of virtual content may be acquired through an external service based on a network. For example, virtual content may be acquired based on Wolfram|Alpha or Google API.

When any one piece of virtual content is acquired through the external service, the acquired virtual content may be stored in the virtual content DB so that the virtual content is associated with the real object information. The virtual content acquired through the external service is stored and managed in this way, and thus it is possible to search the virtual content DB for the corresponding virtual content and provide found virtual content without again searching for virtual content through the external service even if the user subsequently requests virtual content based on the same real object.

Although not shown in FIG. 8, the virtual content provision method for augmenting the usability of a real object according to the embodiment of the present invention may store and manage the one piece of virtual content in the virtual content DB so that the real object matches the one piece of virtual content For example, the virtual content may be stored in the virtual content DB such that an identifier enabling the virtual content to be identified matches object information corresponding to the real object.

Here, the output module may be a projector capable of projecting virtual information or a virtual interface based on the virtual content as an image.

The output module may be installed such that both the real object and environmental information are included in the projection range corresponding to the output module. For example, when the real object is a textbook placed on a desk, the output module may be installed such that the projection range corresponds to the surface of the desk in order to use a note or pen placed on the desk, as well as the textbook, through the virtual content.

Further, the output module may be installed so as to be spaced a predetermined distance apart from a projection surface on which an image is projected or may be installed using a mirror so that the projection range may be secured. For example, the angles of the projector corresponding to the output module and the mirror may be calculated, and thus the projector and the minor may be installed such that the projection range is precisely maintained in a rectangular shape.

Here, the reason for maintaining the projection range in a rectangular shape is that perspective distortion on a projected screen may be prevented, and thus such maintenance may be very important in projection-based display.

Next, the virtual content provision method for augmenting the usability of a real object according to the embodiment of the present invention detects user input on the virtual interface based on the input module at step S830.

Here, the user input may be detected based on a separate marker and a separate input tool recognized by the virtual content provision apparatus, and may be mostly detected based on the hand gesture of the user. Therefore, an image of the 3D hand gesture of the user may be captured using a depth camera, and the captured image may be acquired as the user input.

Further, the virtual content provision method for augmenting the usability of a real object according to the embodiment of the present invention is configured to, when the user input is detected, extract virtual information related to the user input based on the one piece of virtual content, and project and provide the virtual information to correspond to the real object information through the output module at step S840.

Here, the virtual information may correspond to the format of text, an image, video, sound or an interface according to the virtual content. For example, assuming that the virtual content is content related to English education, the virtual information may be either text including the interpretation of English or sound read to provide pronunciation.

In this case, the user input may be delivered to content logic corresponding to the one piece of virtual content, and next state information depending on the user input may be acquired as virtual information based on the content logic. For example, assuming that virtual content is a game having multiple stages, and user input for movement to a next stage is detected, the content logic may provide next stage information, which is the next state information depending on the user input, as the virtual information.

In this regard, an image corresponding to the virtual information generated using at least one of homography, a projected texture, sound, and video based on the virtual information may be generated, and the image may be projected into an area corresponding to at least one of the real object and the environmental information. When the virtual information corresponds to a plane, an image may be generated using homography, and when the virtual information is a solid object, the shape of which is known, an image may be generated using a projected texture.

By utilizing such a virtual content provision method, an additional function suitable for a physical object in the real word may be provided, beyond the intrinsic functions of the physical object, based on augmented reality technology.

Further, the present invention may provide virtual information based on virtual content projected through a projector without requiring a user to wear separate wearable glasses.

Furthermore, the present invention may search for virtual content corresponding to the situation in the real world by recognizing the situation in the real world through a camera, and may provide more effective virtual content by designing and providing the virtual content in conformity with the environment in the real world.

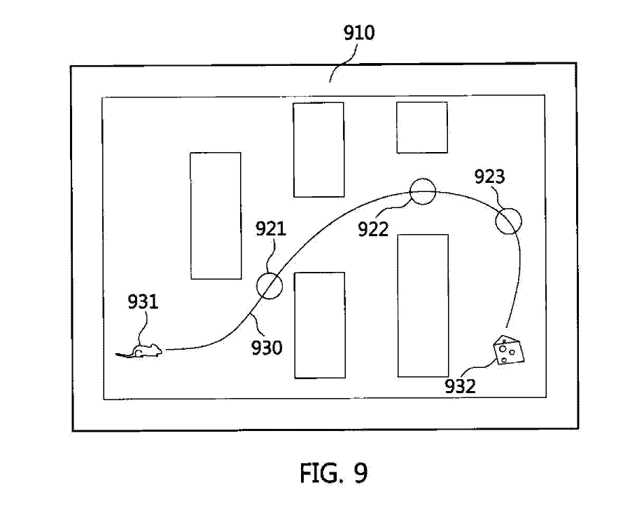

FIG. 9 is a diagram showing an example of a virtual game screen using the virtual content provision apparatus according to the present invention.

Referring to FIG. 9, it can be seen that a virtual game screen 910 using the virtual content provision apparatus according to the present invention basically represents information, content, and an interface in the real world using a projector even if a separate display corresponding to a TV, a smart phone, a smart pad, or wearable glasses is not present That is, the virtual game screen 910 of FIG. 9 may correspond to a screen obtained by projecting virtual game content onto a surface corresponding to a desk, a table or a living room floor, using the projector.

Here, real objects that can be easily obtained by a user who enjoys game content and that can be easily seen may be used as game pieces 921, 922, and 923. The game content may be controlled such that, when the user arranges the game pieces 921, 922, and 923 on the virtual game screen 910, the camera recognizes the game pieces 921, 922, and 923.

In this case, the camera for capturing the game pieces 921, 922, and 923 or the projector for outputting the virtual game screen 910 may be movably attached to a separate pan-tilt device.

Further, for the calibration of a camera position, any planar rectangle, such as a piece of letter-sized (A4) paper or a game board for a board game, may be arranged on the floor on which the virtual game screen 910 is projected.

Here, the virtual game content may correspond to software in which recognition, projection, and application are implemented. Further, the virtual game content may be implemented using online software executed by the user in a work situation and offline software executed to recognize an object and analyze recorded data.

In this case, in a procedure for playing game content corresponding to FIG. 8, using the virtual content provision system according to the embodiment of the present invention, a projector and a camera may be installed in a suitable empty space, in which game content is to be represented, using a holder.

Thereafter, control factors are calibrated based on the intrinsic parameters of the projector and the camera, the positional relationship between the projector and the camera, the size of a recognition range, the size of a projection range, etc., and any rectangle, such as a piece of A4 paper or a game board for a board game, may be arranged in the area viewed through the camera.

Next, the calibration of camera position and orientation based on coupled line cameras may be performed by capturing an image of the rectangle.

Thereafter, the aspect ratio and resolution of the area viewed through the camera are determined in consideration of the possible projection area, and application components may be arranged in conformity with the determined aspect ratio and resolution.

In this case, the graphics of the virtual game content may be provided as vectors in consideration of perspective transformation. For example, in the case of pixel-based graphics, distortion occurs in perspective transformation, and thus line segments may be defined as a rectangle.

Thereafter, parameter calibration for image recognition may be performed to recognize the game pieces 921, 922, and 923. For example, parameter calibration for image recognition may be performed by conducting color transformation based on a Hue, Saturation, Value (HSV) color space.

Then, the virtual game content may be perspective-transformed using the position and orientation of the calibrated projector, and the transformed content may be projected through the projector.

Thereafter, when the user arranges the game pieces 921, 922, and 923 in the area viewed through the camera, the kinds and positions of the game pieces 921, 922, and 923 may be recognized through the camera.

Then, information about the kinds and positions of the game pieces 921, 922, and 923 may be delivered to content logic corresponding to the game content, and the content logic may determine the next state of game play depending on the kinds and positions of the game pieces 921, 922, and 923.

Thereafter, content is prepared by modifying graphic data to correspond to the current state of the game content, and information about the current state may be recorded.

Next, when the input by the user has not yet been terminated, perspective-transformed game content is projected again through the projector, and then the game content may be played.

Here, the game content of FIG. 9 is related to an example in which the user generates a path 930 along which a mouse 931 looks for cheese 932 by moving the game pieces 921, 922, and 923, wherein the path 930 along which the mouse passes through the game pieces 921, 922, and 923 may be determined to be a spline.

In this case, the game content may check whether the path 930 collides with an obstacle such as a wall, and may determine that the corresponding stage was successfully played if the game pieces 921, 922, and 923 are desirably arranged so that the path 930 does not collide with the obstacle.

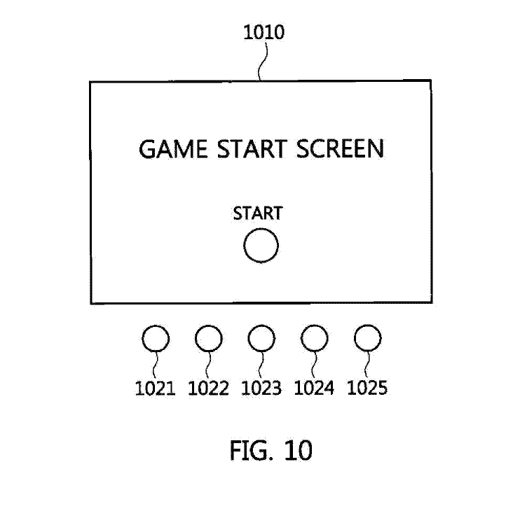

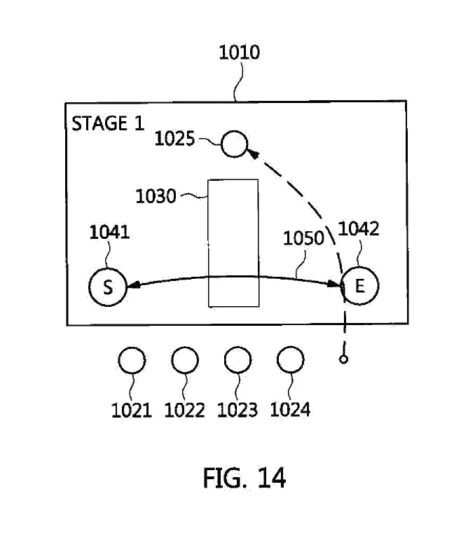

FIGS. 10 to 18 are diagrams showing an embodiment of virtual game content using the virtual content provision apparatus according to the present invention.

Referring to FIGS. 10 to 18, the virtual game content using the virtual content provision apparatus of the present invention is similar to that shown in FIG. 9, and provides a game in which game pieces 1021, 1022, 1023, 1024, and 1025 are arranged on a game screen projected through a projector, after which a movement path from a start point to an end point is generated.

Here, as the game pieces 1021, 1022, 1023, 1024, and 1025, any types of objects may be used as long as they can be easily obtained by the user and have the same shape, and the number of game pieces may be freely set.

Further, the game pieces 1021, 1022, 1023, 1024, and 1025 may be recognized in advance in the game corresponding to virtual content through an input module before the game starts.

The procedure for playing the game will be described as follows.

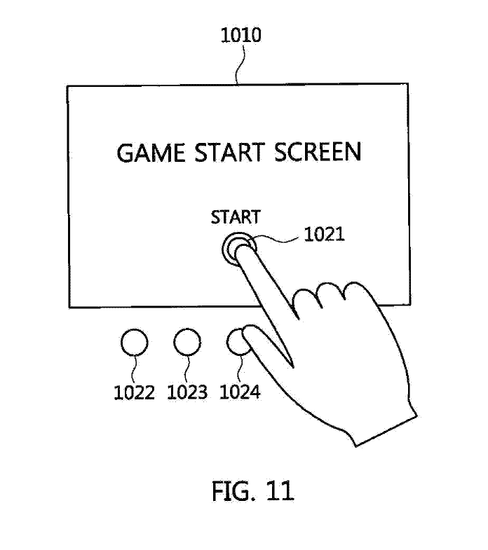

First, as shown in FIG. 10, when a game screen is projected into the projection range 1010 of the projector, the user may move the game piece 1021 to the location of a “start” menu included in the game screen so as to start playing the game, as shown in FIG. 11.

In this case, the input module may recognize the game piece 1021 and detect that user input has occurred, and may acquire the user input depending on the game piece 1021.

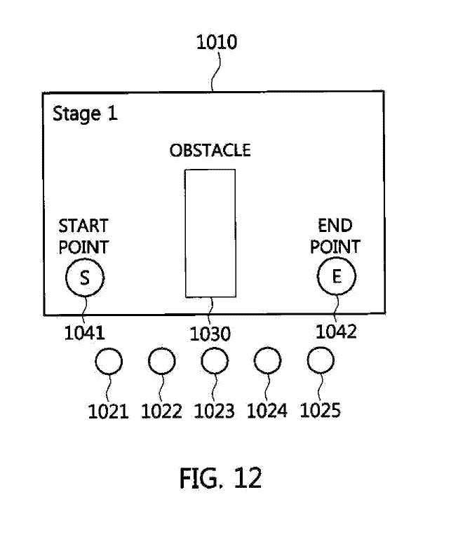

Thereafter, the virtual content provision apparatus may deliver the user input depending on the game piece 1021 to content logic, and may then project an interface related to the playing of the game into the projection range 1010, as shown in FIG. 12.

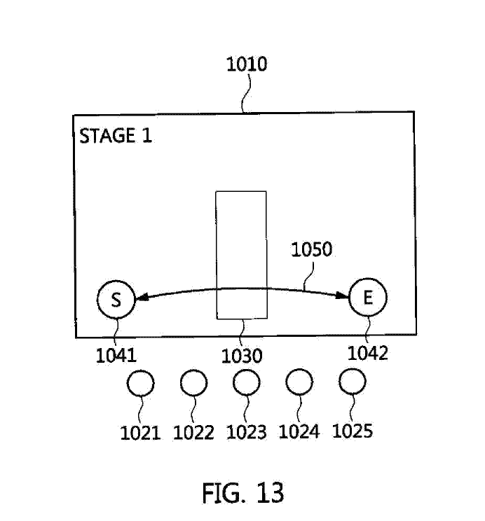

As in the case of the screen shown in FIG. 12, the user generates a path for connecting a start point 1041 to an end point 1042 using the game pieces 1021, 1022, 1023, 1024, and 1025, but may arrange the game pieces 1021, 1022, 1023, 1024, and 1025 so that a path 1050 does not collide with an obstacle 1030, as shown in FIG. 13.

Here, the path 1050 may be generated in the form of a spline which is naturally connected from the start point 1041 to the end point 1042 through the game pieces 1021, 1022, 1023, 1024, and 1025 arranged by the user.

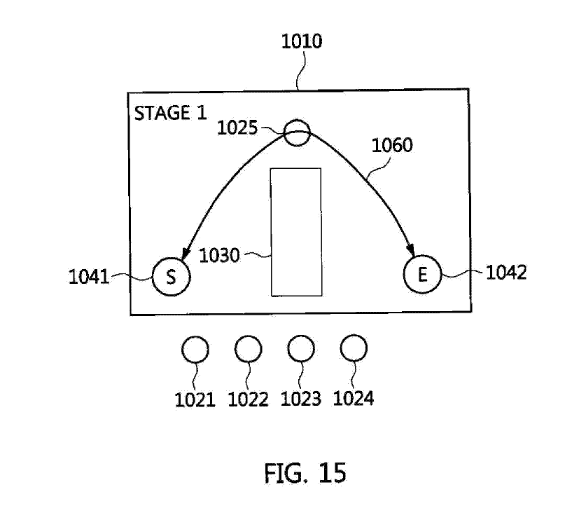

That is, as shown in FIG, 14, control may be performed such that the path 1050 of FIG, 14 is changed to the path 1060 of FIG. 15 by moving the game piece 1025 so as to arrange the game piece 1025 over the obstacle 1030.

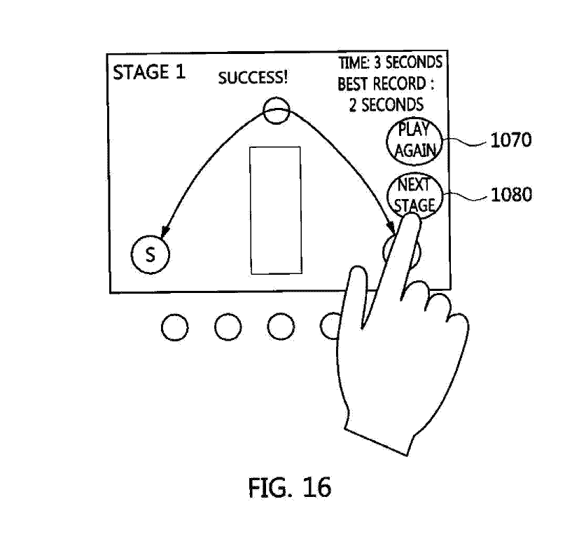

At this time, in the virtual content corresponding to the game, if it is verified that the path 1060 has been connected to the end point 1042 without colliding with the obstacle 1030, it may be determined that the corresponding stage 1 has been successfully played, and the user may play the next stage by additionally providing a “play this stage again” button 1070 and a “next stage” button 1080, as shown in FIG. 16.

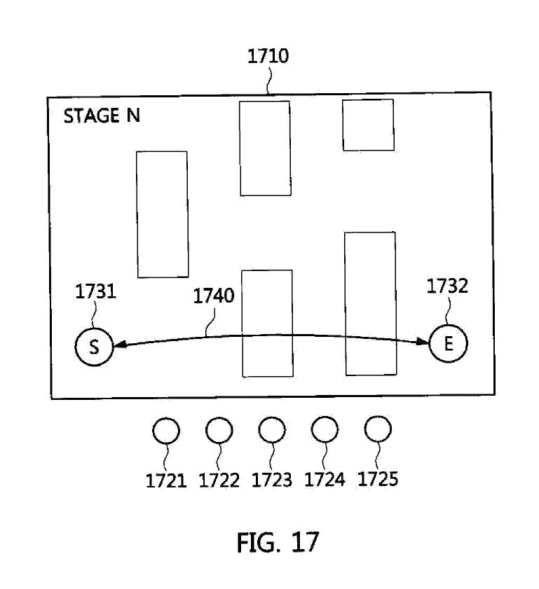

For example, as shown in FIG. 16, when the user selects the “next stage” button 1080, a stage in which more obstacles than those of stage 1 are present, as shown in FIG. 17, may be projected into a projection range 1710 and may then be provided to the user.

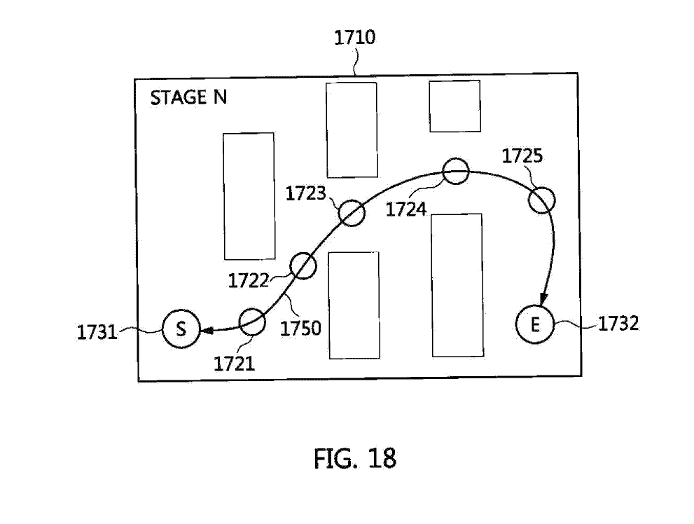

At this time, the user may also generate a more changeable path 1750 by arranging all of game pieces 1721, 1722, 1723, 1724, and 1725, as shown in FIG. 18, so that a path 1740 does not collide with multiple obstacles.

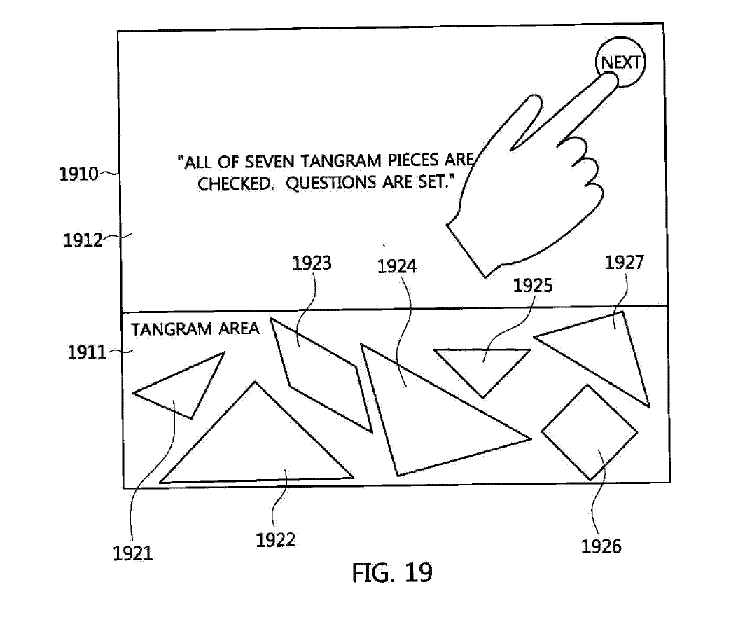

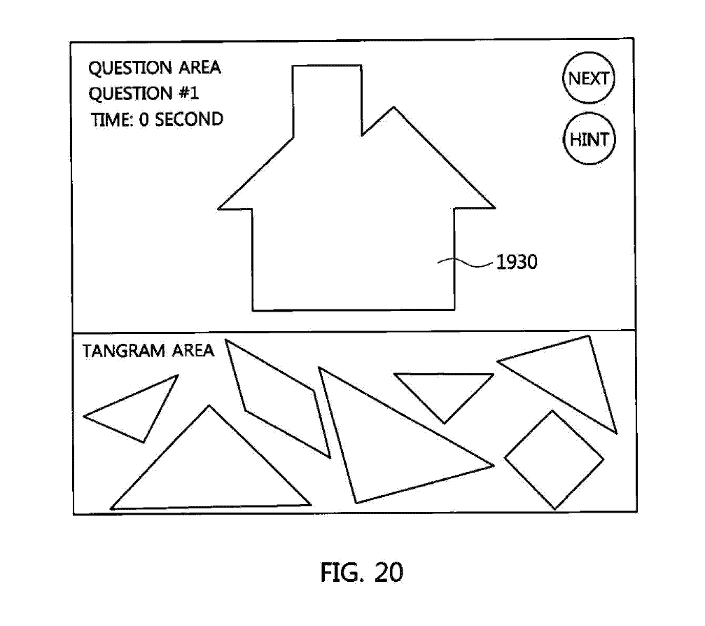

FIGS. 19 to 22 are diagrams showing an embodiment of tangram content using the virtual content provision apparatus according to the present invention.

Referring to FIGS. 19 to 22, the tangram content using the virtual content provision apparatus according to the present invention may recognize seven tangram pieces 1921 to 1927 based on a camera, which is an input module, as shown in FIG. 19. That is, before content is provided, seven tangram pieces 1921 to 1927, which are real objects, may be recognized, and questions that may be provided based on the recognized tangram pieces 1921 to 1927 may be searched for. These characteristics may be utilized even in other pieces of virtual content, as well as the seven tangram pieces 1921 to 1927 according to the present embodiment.

Here, the seven tangram pieces 1921 to 1927 must be arranged at a position that may be recognized by the camera, that is, within an input area 1910, and may also be arranged in a tangram area 1911 that is separately divided according to the tangram content.

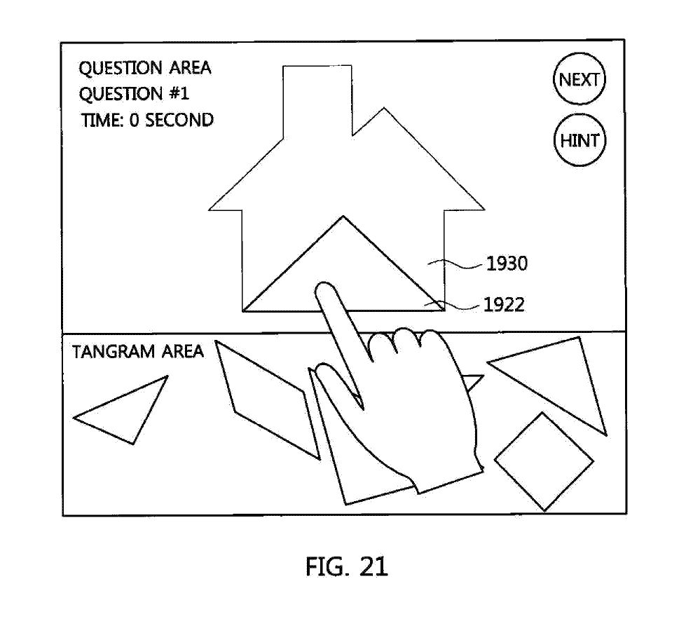

Thereafter, when tangram content provides a question 1930 based on the seven tangram pieces 1921 to 1927 to a question area 1912, as shown in FIG, 20, the user may generate a shape (pattern) corresponding to the question 1930 by individually moving the seven tangram pieces 1921 to 1927 one by one, as shown in FIG. 21.

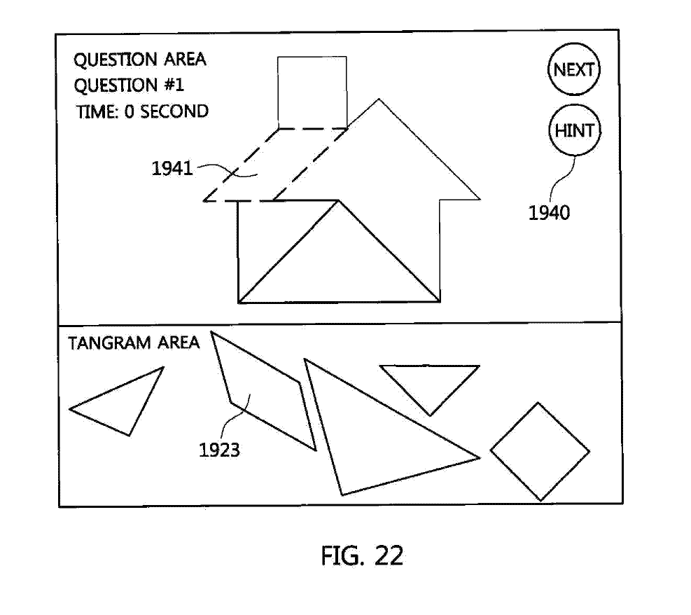

In this case, the tangram content provides a hint menu 1940, as shown in FIG. 22, thus providing hint information 1941 for a tangram piece 1923 that is difficult for the user to arrange.

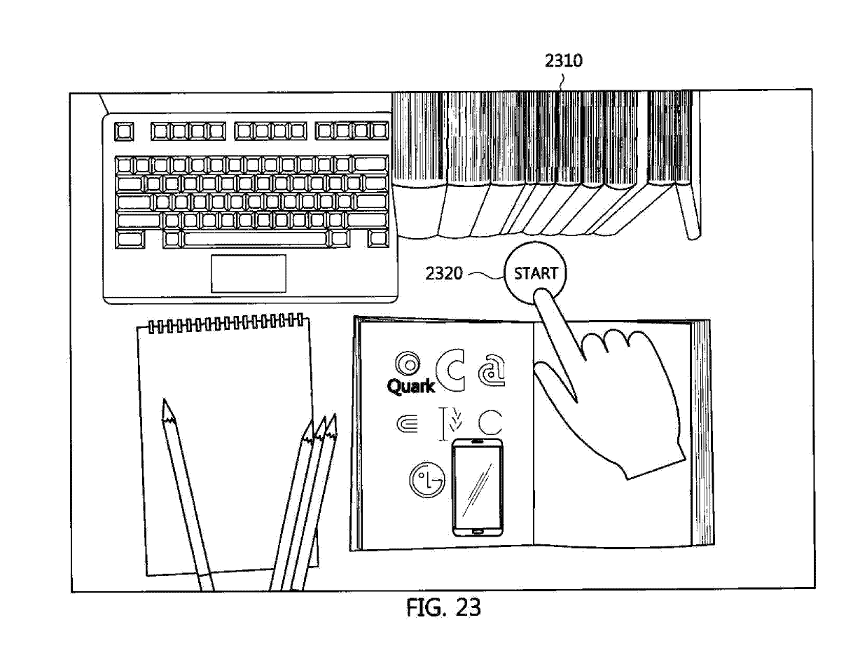

FIGS. 23 to 27 are diagrams showing an embodiment of educational content using the virtual content provision apparatus according to the present invention.

Referring to FIGS. 23 to 27, the educational content using the virtual content provision apparatus according to the present invention may set the surface of a user's desk as a projection range 2310 through a projector, and may provide virtual educational content for providing educational information, as shown in FIG. 23.

Here, the projector and a camera, which correspond to an input module and an output module, respectively, may be present in the form of a reading light in front of the desk.

Below, the procedure for utilizing the educational content will be described.

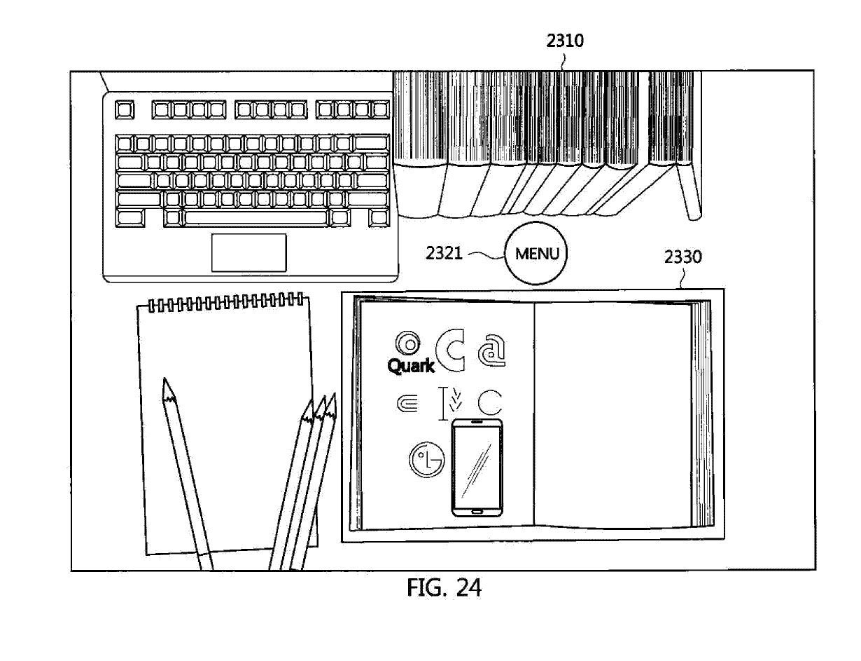

First, as shown in FIG. 23, when the user selects a start button 2320 projected into the projection range 2310, the virtual content provision apparatus may acquire real object information about the textbook 2330 currently being read by the user through the camera, as shown in FIG. 24.

In this case, in the textbook 2330, a marker for educational content may be printed or, alternatively, a marker having a specific shape, attached by the user, may be present.

Next, when real object information about the textbook 2330 may be acquired, after which educational content to be provided to the user is obtained, the user may use the virtual content by providing a menu button 2321.

In this case, a mechanism for allowing the user to select the unit content of the textbook 2330 may be required.

For example, when a marker drawn by a pencil or a pen is selected, an offline recognizer using a separate symbol or color may be provided such that the marker may be recognized.

As another example, when a printed driving marker is hidden or indicated by the pen or the user's hand, a recognizer capable of detecting variation in the vicinity of the marker may be provided.

Further, a mechanism for recognizing pages may also be required. For example, a recognizer for recognizing pages based on the unique content of the pages, or a recognizer for recognizing a marker for distinguishing pages may be provided.

In this case, a service provider that provides educational content may prepare virtual information about the corresponding textbook 2330 in advance. For example, virtual information, such as a broadcast lecture video corresponding to the textbook 2330 or a Korean translation of an English paragraph, may be stored in advance.

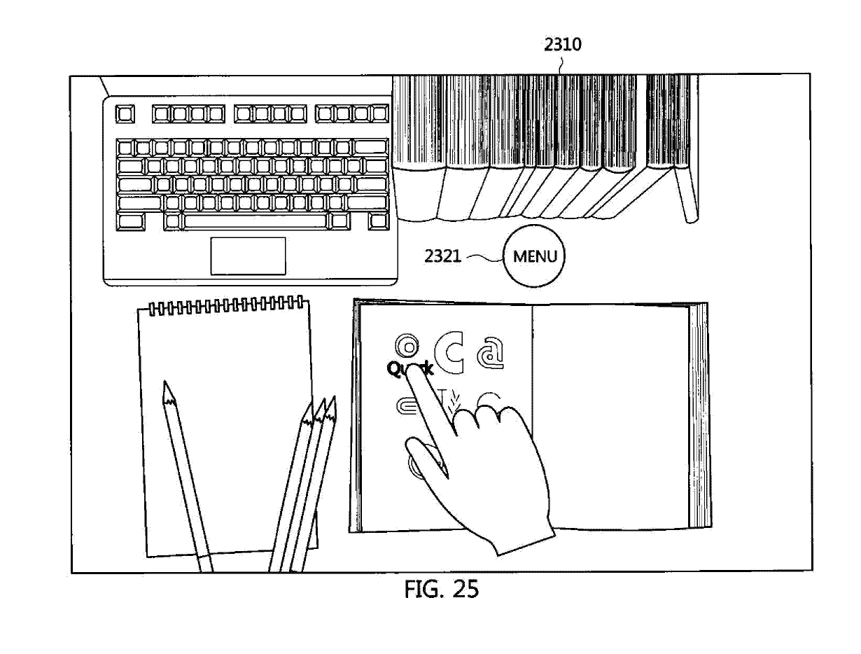

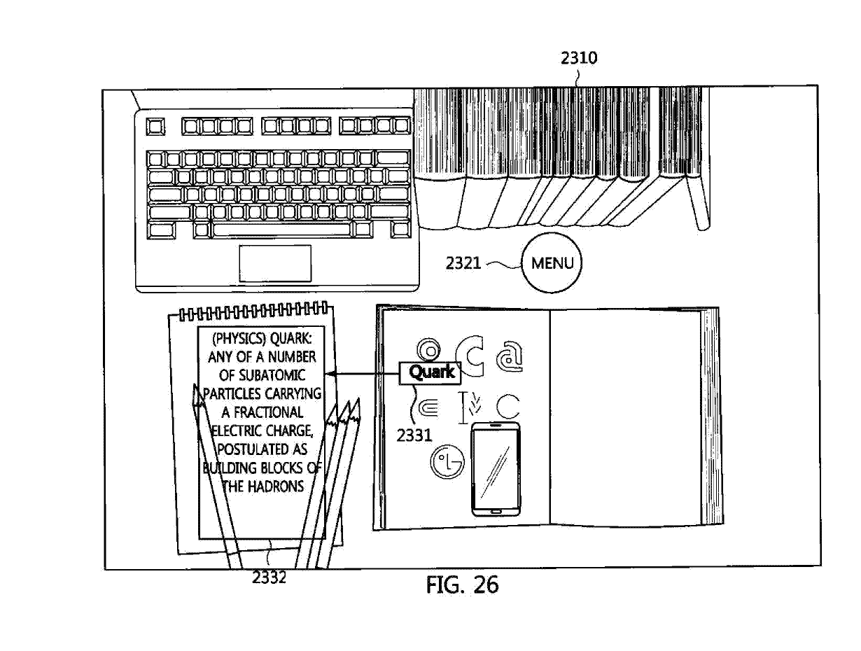

Here, as shown in FIG. 25, when the user selects an English word from the textbook 2330, the educational content may provide the interpretation and meaning of the English word 2331 as the virtual information 2332, as shown in FIG. 26.

In this case, the virtual content provision apparatus may select the position at which the virtual information 2332 is to be projected and provided by obtaining surrounding contextual information, in addition to the textbook 2330 corresponding to the real object, from the projection range 2310.

Further, the user may select content contained in the textbook 2330 using a separate recognizer, such as a pen or a pencil, even if no scheme for allowing the user to point at the content with his or her hand is used.

Furthermore, various functions may be provided via the menu button 2321, thus allowing the user to select and use desired virtual information.

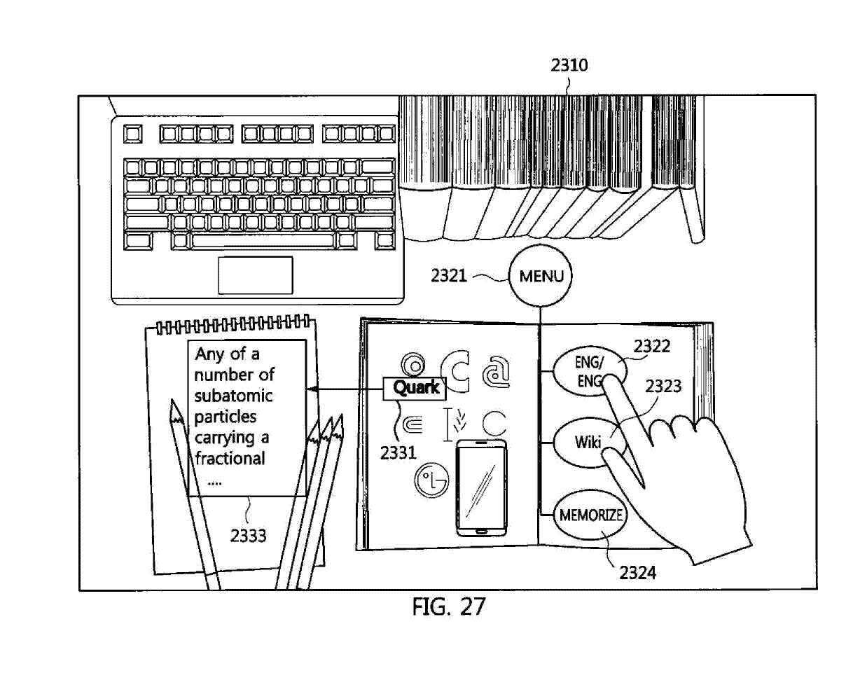

For example, assuming that the user selects an Eng/Eng conversion function 2322 from among functions provided via the menu button 2321, as shown in FIG. 27, English text, obtained by translating previously provided virtual information 2332 into English, may be provided as virtual information 2333.

As another example, assuming that a specific word is marked by a highlighter, the meaning of the word may be indicated, and the pronunciation of the word may be provided as sound.

By means of such educational content, the use may obtain additional information suitable for his or her voluntary selection and learning situation, together with fixed information provided through existing books and textbooks.

In accordance with the present invention, an additional function suitable for a physical object in the real world may be provided, beyond the intrinsic functions of the physical object in the real world, based on augmented-reality technology.

Further, the present invention may provide virtual information based on virtual content projected through a projector without requiring a user to wear separate wearable glasses, thus decreasing dependency on a portable device carried by the user and allowing the user to experience the augmentation of the usability of an object regardless of the user's ability to utilize the device and regardless of the age of the user.

Furthermore, the present invention may search for virtual content corresponding to the situation in the real world by recognizing the situation in the real world through a camera, and may provide more effective virtual content by designing and providing the virtual content in conformity with the environment in the real world.

As described above, in the virtual content provision apparatus and method for augmenting the usability of a real object according to the present invention, the configurations and schemes in the above-described embodiments are not limitedly applied, and some or all of the above embodiments can be selectively combined and configured SO that various modifications are possible.

What is claimed is:

1. A virtual content provision apparatus for augmenting usability of a real object, comprising:
a real object information acquisition unit for acquiring real object information corresponding to a real object through an input module;
a virtual content search unit for searching for any one piece of virtual content based on the real object information;
a virtual interface projection unit for projecting a virtual interface corresponding to the one piece of virtual content onto the real object through an output module;
a user input detection unit for detecting user input on the virtual interface based on the input module; and
a virtual content provision unit for, when the user input is detected, extracting virtual information related to the user input based on the one piece of virtual content, and projecting and providing the virtual information to correspond to the real object information through the output module.

2. The virtual content provision apparatus of claim 1, wherein the virtual content provision unit delivers the user input to content logic corresponding to the one piece of virtual content, and acquires next state information depending on the user input as the virtual information based on the content logic.

3. The virtual content provision apparatus of claim 1, wherein the real object information comprises at least one of object information corresponding to at least one of a kind and a shape of the real object and environmental information corresponding to the real object.

4. The virtual content provision apparatus of claim 3, wherein the virtual content provision unit is configured to generate an image corresponding to the virtual information generated using at least one of homography, a projected texture, sound, and video, based on the virtual information, and to project the image into an area corresponding to at least one of the real object and the environmental information. cm 5. The virtual content provision apparatus of claim 1, wherein the input module is at least one of a sensor, a camera, and a depth camera that correspond to at least one of location, orientation, temperature, body temperature, blood pressure, length, illuminance, and radio frequency identification (RFID).

6. The virtual content provision apparatus of claim 1, wherein the output module is a projector capable of projecting the virtual information as an image.

7. The virtual content provision apparatus of claim 1, further comprising a virtual content database for storing and managing the one piece of virtual content so that the real object matches the one piece of virtual content.

8. The virtual content provision apparatus of claim 7, wherein the virtual content search unit acquires the one piece of virtual content through an external service based on a network if any one piece of virtual content is not found in the virtual content database.

9. The virtual content provision apparatus of claim 8, wherein the virtual content search unit is configured to, if any one piece of virtual content is acquired through the external service, store the one piece of virtual content in the virtual content database so that the one piece of virtual content is associated with the real object information.

10. The virtual content provision apparatus of claim 3, wherein the output module is installed such that both the real object and the environmental information are included in a projection range corresponding to the output module.

11. A virtual content provision method for augmenting usability of areal object, comprising:
acquiring real object information corresponding to a real object through an input module;
searching for any one piece of virtual content based on the real object information, and projecting a virtual interface corresponding to the one piece of virtual content onto the real object through an output module;
detecting user input on the virtual interface based on the input module; and
when the user input is detected, extracting virtual information related to the user input based on the one piece of virtual content, and projecting and providing the virtual information to correspond to the real object information through the output module.

12. The virtual content provision method of claim 11, wherein projecting and providing the virtual information comprises:
delivering the user input to content logic corresponding to the one piece of virtual content; and
acquiring next state information depending on the user input as the virtual information based on the content logic.

13. The virtual content provision method of claim 11, wherein the real object information comprises at least one of object information corresponding to at least one of a kind and a shape of the real object and environmental information corresponding to the real object.

14. The virtual content provision method of claim 13, wherein projecting and providing the virtual information is configured to generate an image corresponding to the virtual information generated using at least one of homography, a projected texture, sound, and video, based on the virtual information, and to project the image into an area corresponding to at least one of the real object and the environmental information.

15. The virtual content provision method of claim 11, wherein the input module is at least one of a sensor, a camera, and a depth camera that correspond to at least one of location, orientation, temperature, body temperature, blood pressure, length, illuminance, and radio frequency identification (RFID).

16. The virtual content provision method of claim 11, wherein the output module is a projector capable of projecting the virtual information as an image.

17. The virtual content provision method of claim 11, further comprising storing and managing the one piece of virtual content in a virtual content database so that the real object matches the one piece of virtual content.

18. The virtual content provision method of claim 17, wherein projecting the virtual interface comprises acquiring the one piece of virtual content through an external service based on a network if any one piece of virtual content is not found in the virtual content database.

19. The virtual content provision method of claim 18, wherein projecting the virtual interface further comprises:
if any one piece of virtual content is acquired through the external service, storing the one piece of virtual content in the virtual content database so that the one piece of virtual content is associated with the real object information.

20. The virtual content provision method of claim 13, wherein the output module is installed such that both the real object and the environmental information are included in a projection range corresponding to the output module.
